(19) United States
(12) Patent Application Publication
(10) Pub. No.: US 2007/0249772 A1
(43) Pub. Date: Oct. 25, 2007

(54) Elastomer Silicone Vulcanizates

(76) Inventors: Igor Chorvath, Midland, MI (US); Lauren Marie Tonge, Sanford, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/596,944

(22) PCT Filed: Jun. 1, 2005
(86) PCT No.: PCT/US05/19320

§ 371 Date: Nov. 17, 2006

Related U.S. Application Data
(60) Provisional application No. 60/584,305, filed on Jun. 30, 2004.

(51) Int. Cl. C08L 27/12; C08L 83/04

(52) U.S. Cl. 524/440; 524/500

(57) ABSTRACT

A method is disclosed for preparing an elastomeric composition comprising: (I) mixing; (A) an elastomer, (B) an optional compatibilizer, (C) an optional catalyst, (D) a silicone base comprising a curable organopolysiloxane, (E) an optional crosslinking agent, (F) a cure agent in an amount sufficient to cure said organopolysiloxane; and then, (II) statically vulcanizing the organopolysiloxane, wherein the weight ratio of elastomer (A) to silicone base (D) in the elastomeric composition ranges from 95:5 to 30:70. The elastomer compositions obtained by the present method and cured elastomeric compositions prepared therefrom have good low and high temperature properties.

### CROSS REFERENCE TO RELATED APPLICATIONS

This application claims priority to U.S. Patent Application No. 60/584,306 as filed, Jun. 30, 2004.

### FIELD OF THE INVENTION

The present invention relates to a method of making an elastomeric composition comprising silicone and another elastomer based on static vulcanization of the silicone. The invention further relates to the product prepared by the method, and the cured elastomeric composition obtained therefrom.

### BACKGROUND OF THE INVENTION

Silicone rubber is characterized by good high and low temperature properties, weather resistance and processing characteristics. A need exists to modify other elastomers in an efficient manner to improve their performance at temperature extremes. In particular, there is a need to provide elastomeric compositions for use in various applications where high and or low temperature properties are required. A need also exists to modify elastomers in an efficient manner to improve their processing.

There have been relatively few successful attempts to provide modified elastomers by the addition of, or combination with, siloxane based polymers. Stable uniform mixtures are difficult to obtain due to the incompatibility of elastomers with these siloxane-based polymers. Moreover, blends must be co-crosslinkable. Some examples to provide elastomer and silicone rubber compositions include U.S. Pat. Nos. 4,942,202, 5,010,137, 5,171,787 and 5,350,804.

U.S. Pat. No. 4,942,202 teaches a rubber composition and vulcanized rubber products. The '202 compositions are prepared by reacting an organic peroxide, under shear deformation, with (I) a silicone rubber, (II) a saturated elastomer that fails to react with an organic peroxide when it is used alone, and (III) another elastomer that is co-crosslinkable with the silicone rubber in the presence of an organic peroxide. The other elastomer (III) is also co-crosslinkable or highly miscible with component (II).

U.S. Pat. No. 5,010,137 teaches rubber compositions, which include elastomers, and oil seals and rubber hoses obtained therefrom. The '137 compositions are obtained by compounding a polyorganohydrogensiloxane and a group VIII transition metal compound with a rubber-forming polymer comprising (I) a vinyl containing polyorganosiloxane and (II) an organic rubber, and subjecting the resulting compound to hydrosilylation while effecting shear deformation.

U.S. Pat. No. 5,171,787 teaches silicone-based composite rubber compositions and uses thereof. The '787 compositions are prepared by compounding a (A) rubber forming polymer comprising a polyorganosiloxane and an organic rubber, (B) a silicon compound having at least two hydrolyzable groups per molecule, and (C) a heavy metal compound, amine, or quaternary ammonium salt which catalyzes the hydrolysis and condensation reaction; and allowing the resulting formulation to undergo hydrolysis and condensation reactions while the formulation is kept from being deformed by shearing; and a crosslinking agent subsequently added followed by crosslinking of said organic rubber.

U.S. Pat. No. 5,350,804 teaches a composite rubber composition which comprises (a) an organic rubbery elastomer composition having a Mooney viscosity of at least 70 at 100° C. forming the matrix phase of the composite rubber composition; and (b) cured silicone rubber as a dispersed phase in the matrix phase.

While these patents provide advances in the field, a need still exists to specifically modify elastomers in an efficient manner to provide lower cost high performance elastomeric systems, while maintaining the inherent physical properties of these systems. In particular, there is a need to provide elastomeric compositions for use in various applications where high and or low temperature properties are required as well as resistance to fuels, oils, exhaust gases, or chemicals.

The present invention provides elastomeric compositions based on the incorporation of silicones with other elastomers using a static vulcanization process. These elastomeric compositions result from the new mixing processes of the present invention. These new mixing processes provide compositions having significant quantities of a silicone rubber based composition incorporated into another elastomer. However, the resulting cured elastomeric composition prepared from the elastomeric compositions of the present invention, maintain many of the desirable physical property attributes of the elastomers.

### SUMMARY OF THE INVENTION

This invention provides a method for preparing an elastomeric composition containing both an elastomer and a silicone wherein a silicone base is mixed with another elastomer, and the silicone base is subsequently statically vulcanized within the elastomer. Thus, the present invention relates to a method for preparing an elastomeric composition comprising:
(I) mixing;
   (A) an elastomer,
   (B) an optional compatibilizer,
   (C) an optional catalyst,
   (D) a silicone base comprising a curable organopolysiloxane,
   (E) an optional crosslinking agent,
   (F) a cure agent in an amount sufficient to cure said organopolysiloxane; and then,
(II) statically vulcanizing the organopolysiloxane,
   wherein the weight ratio of elastomer (A) to silicone base (D) in the elastomeric composition ranges from 95:5 to 30:70.

The invention further relates to the elastomer compositions obtained by the present method and cured elastomeric compositions prepared therefrom.

### DETAILED DESCRIPTION OF THE PREFERRED EMBODIMENTS

Component (A) is an elastomer having a glass transition temperature (T_{g}) below room temperature, alternatively below 23° C., alternatively, below 15° C., alternatively below 0° C. “Glass transition temperature”, means the temperature at which a polymer changes from a glassy vitreous state to a rubbery state. The glass transition temperature can be determined by conventional methods, such as dynamic mechanical analysis (DMA) and Differential Scanning Calorimetry (DSC). As used herein, an “elastomer” excludes silicone based elastomers also known as silicone rubbers. The elastomeric component (A) can be selected from any of the major classes of elastomers and rubbers (ASTM nomenclature shown in parentheses) that are known in the art as natural rubber (NR), isoprene rubber (IR), styrene-butadiene rubber (SBR), butadiene rubber (BR), chloroprene rubber (CR), chlorinated polyethylene (CPE), butyl rubber, acrylonitrile-butadiene rubber (NBR), chlorosulfonated polyethylene (CSM), acrylic rubber (ACM), epichlorohydrin rubber (ECO), ethylene-vinyl acetate rubber (EVM), ethylene-acrylic rubber, ethylene-α-olefin copolymerized rubber, ethylene-α-olefin-diene terpolymerized rubber (EPDM), fluorocarbon elastomers (FKM), and hydrogenated nitrile rubber (HNBR).

Alternatively, the elastomer is a high performance elastomer selected from chlorosulfonated polyethylene (CSM), chlorinated polyethylene (CPE/CM), ethylene-vinyl acetate rubber (EVM), epichlorohydrin rubber (ECO), and acrylic rubber (ACM). Alternatively, the elastomer is selected from ethylene-α-olefin-diene terpolymerized rubber (EPDM), hydrogenated nitrile rubber (HNBR), and fluorocarbon elastomers (FKM).

In the chemically modified elastomer embodiment described infra, (A) is selected from an elastomer comprising a polymer that can react with the compatibilizer (B) and optionally catalyst (C) to produce a modified elastomer. Although not wishing to be bound by any theory, the present inventors believe that in the chemical modification embodiment any elastomer or modified elastomers can be selected as component (A) providing that the elastomer contains at least one group capable of reacting with at least a portion of the silicone base. In other words, the elastomer should be capable of reacting with the silicone base via the operative cure mechanism selected for the organopolysiloxane. A cure agent (F) is added to the organopolysiloxane, component (D), and optionally crosslinker component (E), to cure the organopolysiloxane via a static vulcanization process. Typically during the static vulcanization process, i.e. step (II), the cure chemistry occurring at the surface of the silicone compound can also react with the elastomer, which furthers the dispersion of the silicone within the elastomer. Representative non-limiting examples of the reactive groups on the elastomer include methyl, methylene, vinyl, and halogens. For example, a methyl or methylene group on the elastomer could react with a peroxide, selected as the cure agent for the silicone compound, thus forming a bond between the organopolysiloxane and the elastomer. As another example, a vinyl group on the elastomer could react via the addition cure mechanism or radical cure mechanism.

It is anticipated that the elastomer, component (A), can be a mixture of polymers. However in the chemically modified elastomer embodiment, at least 2 wt. %, alternatively at least 5 wt. %, or alternatively at least 10% of the elastomer composition should contain a polymer having a reactive group capable of reacting with the cure chemistry of the organopolysiloxane.

Optional compatibilizer (B) can be selected from any hydrocarbon, organosiloxane, fluorocarbon, or combinations thereof that would be expected to modify the elastomer in a manner to enhance the mixing of the silicone base (D) with the elastomer (A) to produce a mixture having a continuous elastomer phase and a discontinuous (i.e. internal phase) silicone phase. Generally, the compatibilizer can be one of two types. In a first embodiment, herein referred to as a physical compatibilizer, the compatibilizer is selected from any hydrocarbon, organosiloxane, fluorocarbon, or combinations thereof, that would not be expected to react with the elastomer (A), yet still enhance the mixing of the elastomer with the silicone base. In a second embodiment herein referred to as a chemical compatibilizer, the compatibilizer is selected from any hydrocarbon, organosiloxane, or fluorocarbon or combinations thereof that could react chemically with the elastomers and or silicone rubber. However in either embodiment, the compatibilizer must not prevent the static cure of the organopolysiloxane component, described infra.

In the physically modified embodiment, the compatibilizer (B) can be selected from any compatibilizer known in the art to enhance the mixing of a silicone base with an elastomer.

In the chemically modified embodiment, typically the compatibilizer (B) can be selected from (B¹) organic (i.e., non-silicone) compounds which contain 2 or more olefin groups, (B²) organopolysiloxanes containing at least 2 alkenyl groups, (B³) olefin-functional silanes which also contain at least one hydrolyzable group or at least one hydroxyl group attached to a silicon atom thereof, (B⁴) an organopolysiloxane having at least one organofunctional groups selected from amine, amide, isocyanurate, phenol, acrylate, epoxy, and thiol groups, (B⁵) an dehydrofluorination agent, and any combinations of (B¹), (B²), (B³), (B⁴), and (B⁵).

Organic compatibilizer (B′) can be illustrated by compounds such as diallyphthalate, triallyl isocyanurate, 2,4,6-triallyloxy-1,3,5-triazine, triallyl trimesate, 1,5-hexadiene, low molecular weight polybutadienes, 1,7-octadiene, 2,2′-diallylbisphenol A, N,N′-diallyl tartardiamide, diallylurea, diallyl succinate and divinyl sulfone, inter alia.

Compatibilizer (B″) may be selected from linear, branched or cyclic organopolysiloxanes having at least 2 alkenyl groups in the molecule. Examples of such organopolysiloxanes include divinyltetramethyldisiloxane, cyclotrimethyltrivinyltrisiloxane, cyclo-tetramethyltetravinyltetrasiloxane, hydroxy end-blocked polymethylvinylsiloxane, hydroxy terminated polymethylvinylsiloxane-co-polydimethylsiloxane, dimethylvinylsiloxy terminated polydimethylsiloxane, tetrakis(dimethylvinylsiloxy)silane and tris(dimethylvinylsiloxy)phenylsilane. Alternatively, compatibilizer (B″) is a hydroxy terminated polymethylvinylsiloxane [HO(MeViSiO)ₓH] oligomer having a viscosity of about 25-100 m Pa-s, containing 20-35% vinyl groups and 2-4% silicon-bonded hydroxy groups.

Compatibilizer (B′″) is a silane, which contains at least one alkylene group, typically comprising vinylic unsaturation, as well as at least one silicon-bonded moiety selected from hydrolyzable groups or a hydroxyl group. Suitable hydrolyzable groups include alkoxy, aryloxy, acyloxy or amido groups. Examples of such silanes are vinyltriethoxysilane, vinyltrimethoxysilane, hexenyltriethoxysilane, hexenyltrimethoxy, methylvinyldisilanol, octenyltriethoxysilane, vinyltriacetoxysilane, vinyltris(2-ethoxyethoxy)silane, methylvinylbis(N-methylacetamido)silane, methylvinyldisilanol.

Compatibilizer (B″″) is an organopolysiloxane having at least one organofunctional groups selected from amine, amide, isocyanurate, phenol, acrylate, epoxy, and thiol groups.

It is possible that a portion of the curable organopolysiloxane of the silicone base component (D) described infra, can also function as a compatibilizer. For example, a catalyst (C) can be used to first react a portion of the curable organopolysiloxane of silicone base (D) with the elastomer to produce a modified elastomer. The modified elastomer is then further mixed with the remaining silicone base (D) containing the curable organopolysiloxane, and the organopolysiloxane is statically vulcanized as described infra.

The amount of compatibilizer used per 100 parts of elastomer can be determined by routine experimentation. Typically, 0.05 to 15 parts by weight, alternatively 0.05 to 10 parts by weight, or alternatively 0.1 to 5 parts of the compatibilizer is used for each 100 parts of elastomer (A).

Optional component (C) is a catalyst. Typically, the catalyst is used in the chemically modified embodiment. As such, it is typically a radical initiator selected from any organic compound, which is known in the art to generate free radicals at elevated temperatures. The initiator is not specifically limited and may be any of the known azo or diazo compounds, such as 2,2′-azobisisobutyronitrile, but it is preferably selected from organic peroxides such as hydroperoxides, diacyl peroxides, ketone peroxides, peroxyesters, dialkyl peroxides, peroxydicarbonates, peroxyketals, peroxy acids, acyl alkylsulfonyl peroxides and alkyl monoperoxydicarbonates. A key requirement, however, is that the half life of the initiator be short enough so as to promote reaction of compatibilizer (B) with the elastomer (A) within the time and temperature constraints of the step (I). The modification temperature, in turn, depends upon the type of elastomer and compatibilizer chosen and is typically as low as practical consistent with uniform mixing of components (A) through (C). Specific examples of suitable peroxides which may be used according to the method of the present invention include: 2,5-dimethyl-2,5-di(tert-butylperoxy)hexane; benzoyl peroxide; dicumyl peroxide; t-butyl peroxy O-toluate; cyclic peroxyketal; t-butyl hydroperoxide; t-butyl peroxypivalate; lauroyl peroxide; t-amyl peroxy 2-ethylhexanoate; vinyltris(t-butyl peroxy)silane; di-t-butyl peroxide, 1,3-bis(t-butylperoxyisopropyl) benzene; 2,2,4-trimethylpentyl-2-hydroperoxide; 2,5-bis(t-butylperoxy)-2,5-dimethylhexyne-3, t-butyl-peroxy-3,5,5-trimethylhexanoate; cumene hydroperoxide; t-butyl peroxybenzoate; and diisopropylbenzene mono hydroperoxide. Less than 2 part by weight of peroxide per 100 parts of elastomer is typically used. Alternatively, 0.05 to 1 parts, and 0.2 to 0.7 parts, can also be employed.

Component (D) is a silicone base comprising a curable organopolysiloxane (D′) and optionally, a filler (D″). A curable organopolysiloxane is defined herein as any organopolysiloxane having at least two curable groups present in its molecule. Organopolysiloxanes are well known in the art and are often designated as comprising any number of M units (R₃SiO_{0.5}), D units (R₂SiO), T units (RSiO_{1.5}), or Q units (SiO₂) where R is independently any monovalent hydrocarbon group. Alternatively, organopolysiloxanes are often described as having the following general formula, [RₘSi(O)_{4-m/2}]ₙ, where R is independently any monovalent hydrocarbon group and m=1-3, and n is at least two.

The organopolysiloxane in the silicone base (D) must have at least two curable groups in its molecule. As used herein, a curable group is defined as any hydrocarbon group that is capable of reacting with itself or another hydrocarbon group, or alternatively with a crosslinker to crosslink the organopolysiloxane. This crosslinking results in a cured organopolysiloxane. Representative of the types of curable organopolysiloxanes that can be used in the silicone base are the organopolysiloxanes that are known in the art to produce silicone rubbers upon curing. Representative, non-limiting examples of such organopolysiloxanes are disclosed in “Encyclopedia of Chemical Technology”, by Kirk-Othmer, 4^{th} Edition, Vol. 22, pages 82-142, John Wiley & Sons, NY which is hereby incorporated by reference. Typically, organopolysiloxanes can be cured via a number of crosslinking mechanisms employing a variety of cure groups on the organopolysiloxane, cure agents, and optional crosslinking agent. While there are numerous crosslinking mechanisms, three of the more common crosslinking mechanisms used in the art to prepare silicone rubbers from curable organopolysiloxanes are free radical initiated crosslinking, hydrosilylation or addition cure, and condensation cure. Thus, the curable organopolysiloxane can be selected from, although not limited to, any organopolysiloxane capable of undergoing any one of these aforementioned crosslinking mechanisms. The selection of components (D), (E), and (F) are made consistent with the choice of cure or crosslinking mechanisms. For example if hydrosilylation or addition cure is selected, then a silicone base comprising an organopolysiloxane with at least two vinyl groups (curable groups) would be used as component (D′), an organohydrido silicon compound would be used as component (E), and a platinum catalyst would be used as component (F). For condensation cure, a silicone base comprising an organopolysiloxane having at least 2 silicon bonded hydroxy groups (ie silanol, considered as the curable groups) would be selected as component (D) and a condensation cure catalyst known in the art, such as a tin catalyst, would be selected as component (F). For free radical initiated crosslinking, any organopolysiloxane can be selected as component (D), and a free radical initiator would be selected as component (F) if the combination will cure within the time and temperature constraints of the static vulcanization step (II). Depending on the selection of component (F) in such free radical initiated crosslinking, any alkyl group, such as methyl, can be considered as the curable groups, since they would crosslink under such free radical initiated conditions.

The quantity of the silicone phase, as defined herein as the combination of components (D), (E) and (F), used can vary depending on the amount of elastomer (A) used.

It is convenient to report the weight ratio of elastomer (A) to the silicone base (D) which typically ranges from 95:5 to 30:70, alternatively 90:10 to 40:60, alternatively 80:20 to 40:60.

In the addition cure embodiment of the present invention, the selection of components (D), (E), and (F) can be made to produce a silicon rubber during the vulcanization process via hydrosilylation cure techniques. This embodiment is herein referred to as the hydrosilylation cure embodiment. Thus, in the hydrosilylation cure embodiment, (D′) is selected from a diorganopolysiloxane gum, which contains at least 2 alkenyl groups having 2 to 20 carbon atoms and optionally (D″), a reinforcing filler. The alkenyl group is specifically exemplified by vinyl, allyl, butenyl, pentenyl, hexenyl and decenyl, preferably vinyl or hexenyl. The position of the alkenyl functionality is not critical and it may be bonded at the molecular chain terminals, in non-terminal positions on the molecular chain or at both positions. Typically, the alkenyl group is vinyl or hexenyl and that this group is present at a level of 0.0001 to 3 mole percent, alternatively 0.0005 to 1 mole percent, in the diorganopolysiloxane. The remaining (i.e., non-alkenyl) silicon-bonded organic groups of the diorganopolysiloxane are independently selected from hydrocarbon or halogenated hydrocarbon groups, which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. It will be understood, of course, that these groups are selected such that the diorganopolysiloxane has a glass temperature, which is below room temperature, and the cured polymer is therefore elastomeric. Typically, the non-alkenyl silicon-bonded organic groups in the diorganopolysiloxane makes up at least 85, or alternatively at least 90 mole percent, of the organic groups in the diorganopolysiloxanes.

Thus, polydiorganosiloxane (D′) can be a homopolymer, a copolymer or a terpolymer containing such organic groups. Examples include homopolymers comprising dimethylsiloxy units, homopolymers comprising 3,3,3-trifluoropropylmethylsiloxy units, copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others. The molecular structure is also not critical and is exemplified by straight-chain and partially branched straight-chain structures, the linear systems being the most typical.

Specific illustrations of diorganopolysiloxane (D′) include: trimethylsiloxy-endblocked dimethylsiloxane-methylvinylsiloxane copolymers; trimethylsiloxy-endblocked methylphenylsiloxane-dimethylsiloxane-methylvinylsiloxane copolymers; trimethylsiloxy-endblocked 3,3,3-trifluoropropyhnethyl siloxane copolymers; trimethylsiloxy-endblocked 3,3,3-trifluoropropylmethyl-methylvinylsiloxane copolymers; dirnethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers; and similar copolymers wherein at least one end group is dimethylhydroxysiloxy. Typical systems for low temperature applications include methylphenylsiloxane-dimethylsiloxane-methylvinylsiloxane copolymers and diphenylsiloxane-dimethylsiloxane-methylvinylsiloxane copolymers, particularly wherein the molar content of the dimethylsiloxane units is about 85-95%.

The organopolysiloxane may also consist of combinations of two or more organopolysiloxanes. Alternatively, diorganopolysiloxane (D′) is a linear polydimethylsiloxane homopolymer and is preferably terminated with a vinyl group at each end of its molecule or it is such a homopolymer, which also contains at least one vinyl group along its main chain.

For the purposes of the present invention, the preferred diorganopolysiloxane is a diorganopolysiloxane gum with a molecular weight sufficient to impart a Williams plasticity number of at least about 30 as determined by the American Society for Testing and Materials (ASTM) test method 926. Although there is no absolute upper limit on the plasticity of component (D′), practical considerations of processability in conventional mixing equipment generally restrict this value. Typically, the plasticity number should be 40 to 200, or alternatively 50 to 150.

Methods for preparing high consistency unsaturated group-containing diorganopolysiloxanes are well known and they do not require a detailed discussion in this specification.

Optional component (D″) is any filler which is known to reinforce diorganopolysiloxane (D′) and is preferably selected from finely divided, heat stable minerals such as fumed and precipitated forms of silica, silica aerogels and titanium dioxide having a specific surface area of at least about 50 m²/gram. The fumed form of silica is a typical reinforcing filler based on its high surface area, which can be up to 450 m²/gram. Alternatively, a fumed silica having a surface area of 50 to 400 m²/g, or alternatively 90 to 380 m²/g, can be used. The filler is added at a level of about 5 to about 150 parts by weight, alternatively 10 to 100 or alternatively 15 to 70 parts by weight, for each 100 parts by weight of diorganopolysiloxane (D′).

The filler is typically treated to render its surface hydrophobic, as typically practiced in the silicone rubber art. This can be accomplished by reacting the silica with a liquid organosilicon compound, which contains silanol groups or hydrolyzable precursors of silanol groups. Compounds that can be used as filler treating agents, also referred to as anti-creping agents or plasticizers in the silicone rubber art, include such ingredients as low molecular weight liquid hydroxy- or alkoxy-terminated polydiorganosiloxanes, hexaorganodisiloxanes, cyclodimethylsilazanes and hexaorganodisilazanes.

Component (D) may also contain other materials commonly used in silicone rubber formulations including, but not limited to, antioxidants, crosslinking auxiliaries, processing agents, pigments, and other additives known in the art which do not interfere with step (II) described infra.

In the hydrosilylation cure embodiment of the present invention, compound (E) is added and is an organohydrido silicon compound (E′), that crosslinks with the diorganopolysiloxane (D′). The organohydrido silicon compound is an organopolysiloxane which contains at least 2 silicon-bonded hydrogen atoms in each molecule which are reacted with the alkenyl functionality of (D′) during the static vulcanization step (II) of the present method. A further (molecular weight) limitation is that Component (E′) must have at least about 0.1 weight percent hydrogen, alternatively 0.2 to 2 or alternatively 0.5 to 1.7, percent hydrogen bonded to silicon. Those skilled in the art will, of course, appreciate that either the diorganopolysiloxane (D′) or component (E′), or both, must have a functionality greater than 2 to cure the diorganopolysiloxane (i.e., the sum of these functionalities must be greater than 4 on average). The position of the silicon-bonded hydrogen in component (E′) is not critical, and it may be bonded at the molecular chain terminals, in non-terminal positions along the molecular chain or at both positions. The silicon-bonded organic groups of component (E′) are independently selected from any of the saturated hydrocarbon or halogenated hydrocarbon groups described above in connection with diorganopolysiloxane (D′), including preferred embodiments thereof. The molecular structure of component (E′) is also not critical and is exemplified by straight-chain, partially branched straight-chain, branched, cyclic and network structures, network structures, linear polymers or copolymers being typical. It will, of course, be recognized that this component must be compatible with D′ (i.e., it is effective in curing the diorganopolysiloxane).

Component (E′) is exemplified by the following:

low molecular weight siloxanes such as PhSi(OSiMe₂H)₃;

trimethylsiloxy-endblocked methylhydridopolysiloxanes;

trimethylsiloxy-endblocked dimethylsiloxane-methylhydridosiloxane copolymers;

dimethylhydridosiloxy-endblocked dimethylpolysiloxanes;

dimethylhydrogensiloxy-endblocked methylhydrogenpolysiloxanes;

dimethylhydridosiloxy-endblocked dimethylsiloxane-methylhydridosiloxane copolymers;

cyclic methylhydrogenpolysiloxanes;

cyclic dimethylsiloxane-methylhydridosiloxane copolymers;

tetrakis(dimethylhydrogensiloxy)silane; trimethylsiloxy-endblocked methylhydridosiloxane polymers containing SiO_{4/2} units; silicone resins composed of (CH₃)₂HSiO_{1/2}, and SiO_{4/2} units; silicone resins composed of (CH₃)₂HSiO_{1/2}, (CH₃)₃SiO_{1/2}, and SiO_{4/2} units; silicone resins composed of (CH₃)₂HSiO_{1/2} and CF₃CH₂CH₃SiO_{3/2}; and

silicone resins composed of (CH₃)₂HSiO_{1/2}, (CH₃)₃SiO_{1/2},

CH₃ SiO_{3/2}, PhSiO_{3/2} and SiO_{4/2} units,

wherein Ph hereinafter denotes phenyl radical.

Typical organohydrido silicon compounds are polymers or copolymers comprising RHSiO units terminated with either R₃SiO_{1/2} or HR₂SiO_{1/2} units wherein R is independently selected from alkyl radicals having 1 to 20 carbon atoms, phenyl or trifluoropropyl, typically methyl. Also, typically the viscosity of component (E′) is about 0.5 to 3,000 mPa-s at 25° C., alternatively 1 to 2000 mPa-s. Component (E′) typically has 0.5 to 1.7 weight percent hydrogen bonded to silicon. Alternatively, component (E′) is selected from a polymer consisting essentially of methylhydridosiloxane units or a copolymer consisting essentially of dimethylsiloxane units and methylhydridosiloxane units, having 0.5 to 1.7 weight percent hydrogen bonded to silicon and having a viscosity of 1 to 2000 mPa-s at 25° C. Such a typical system has terminal groups selected from trimethylsiloxy or dimethylhydridosiloxy groups. Alternatively, component (E′) is selected from copolymer or network structures comprising resin units. The copolymer or network structures units comprise RSiO_{3/2} units or SiO_{4/2} units, and may also contain R₃SiO_{1/2}, R₂SiO_{2/2}, and or RSiO_{3/2} units wherein R is independently selected from hydrogen or alkyl radicals having 1 to 20 carbon atoms, phenyl or trifluoropropyl, typically methyl. It is understood that sufficient R as hydrogen is selected such that component (E′) typically has 0.5 to 1.7 weight percent hydrogen bonded to silicon. Also, typically the viscosity of component (E′) is about 0.5 to 3,000 mPa-s at 25° C., alternatively 1 to 2000 mPa-s. Component (E′) may also be a combination of two or more of the above described systems.

The organohydrido silicon compound (E′) is used at a level sufficient to cure diorganopolysiloxane (D′) in the presence of component (F), described infra. Typically, its content is adjusted such that the molar ratio of SiH therein to Si-alkenyl in (D′) is greater than 1. Typically, this SiH/alkenyl ratio is below about 50, alternatively 1 to 20 or alternatively 1 to 12. These SiH-functional materials are well known in the art and many are commercially available.

In the hydrosilylation cure embodiment of the present invention, component (F) is a hydrosilation catalyst (F′), that accelerates the cure of the diorganopolysiloxane. It is exemplified by platinum catalysts, such as platinum black, platinum supported on silica, platinum supported on carbon, chloroplatinic acid, alcohol solutions of chloroplatinic acid, platinum/olefin complexes, platinum/alkenylsiloxane complexes, platinum/beta-diketone complexes, platinum/phosphine complexes and the like; rhodium catalysts, such as rhodium chloride and rhodium chloride/di(n-butyl)sulfide complex and the like; and palladium catalysts, such as palladium on carbon, palladium chloride and the like. Component (F′) is typically a platinum-based catalyst such as chloroplatinic acid; platinum dichloride; platinum tetrachloride; a platinum complex catalyst produced by reacting chloroplatinic acid and divinyltetramethyldisiloxane which is diluted with dimethylvinylsiloxy endblocked polydimethylsiloxane, prepared according to U.S. Pat. No. 3,419,593 to Willing; and a neutralized complex of platinous chloride and divinyltetramethyldisiloxane, prepared according to U.S. Pat. No. 5,175,325 to Brown et al. , these patents being hereby incorporated by reference. Alternatively, catalyst (F) is a neutralized complex of platinous chloride and divinyltetramethyldisiloxane.

Component (F′) is added to the present composition in a catalytic quantity sufficient to promote the reaction between organopolysiloxane (D′) and component (E′) so as to cure the organopolysiloxane within the time and temperature limitations of the static vulcanization step (II). Typically, the hydrosilylation catalyst is added so as to provide about 0.1 to 500 parts per million (ppm) of metal atoms based on the total weight of the elastomeric composition, alternatively 0.25 to 50 ppm.

In another embodiment, components (D), (E), and (F) are selected to provide a condensation cure of the organopolysiloxane. For condensation cure, an organopolysiloxane having at least 2 silicon bonded hydroxy groups (i.e. silanol, considered as the curable groups) would be selected as component (D), a organohydrido silicon compound would be selected as the optional crosslinking agent (E), and a condensation cure catalyst known in the art, such as a tin catalyst, would be selected as component (F). The organopolysiloxanes useful as condensation curable organopolysiloxanes is any organopolysiloxane which contains at least 2 silicon bonded hydroxy groups (or silanol groups (SiOH)) in its molecule. Typically, any of the organopolysiloxanes described infra as component (D) in the addition cure embodiment, can be used as the organopolysiloxane in the condensation cure embodiment if at least two SiOH groups are additionally present,, although the alkenyl group would not be necessary in the condensation cure embodiment. The organohydrido silicon compound useful as the optional crosslinking agent (E) is the same as described infra for component (E). The condensation catalyst useful as the curing agent in this embodiment is any compound which will promote the condensation reaction between the SiOH groups of diorganopolysiloxane (D) and the SiH groups of organohydrido silicon compound (E) so as to cure the former by the formation of —S—O—Si— bonds. Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide (see, e.g., U.S. Pat. No. 3,024,210).

In yet another embodiment, components (D), (E), and (F) can be selected to provide a free radical cure of the organopolysiloxane. In this embodiment, the organopolysiloxane can be any organopolysiloxane but typically, the organopolysiloxane has at least 2 alkenyl groups. Thus, any of the organopolysiloxane described supra as suitable choices for (D′) in the addition cure embodiment can also be used in the free radical embodiment of the present invention. A crosslinking agent (E) is not required, but may aid in the free radical cure embodiment. The cure agent (F) can be selected from any of the free radical initiators described supra for the selection of component (C).

In addition to the above-mentioned major components (A) through (F), a minor amount (i.e., less than 50 weight percent of the total composition) of one or more optional additive (G) can be incorporated in the elastomeric compositions of the present invention. These optional additives can be illustrated by the following non-limiting examples: extending fillers such as quartz, calcium carbonate, and diatomaceous earth; pigments such as iron oxide and titanium oxide; fillers such as carbon black and finely divided metals; heat stabilizers such as hydrated cerric oxide, calcium hydroxide, magnesium oxide; and flame retardants such as halogenated hydrocarbons, alumina trihydrate, magnesium hydroxide, wollastonite, organophosphorous compounds and other fire retardant (FR) materials. These additives are typically added to the final composition after static cure, but they may also be added at any point in the preparation provided they do not interfere with the static vulcanization mechanism. These additives can be the same, or different, as the additional components added to prepare the cured elastomeric compositions, described infra.

Mixing for step (I) can be performed in any device that is capable of uniformly mixing the components (B) through (G) with (A) the elastomer. Typically the mixing by an extrusion process is conducted on a twin-screw extruder. The order of mixing components (A) through (F) is not critical. Typically (G) would be added after (F) but it is not critical as long as (G) does not interfere with cure of the organopolysiloxane (e.g., (G) can be premixed with the elastomer (A) and/or with the silicone base (D).

In one embodiment of the present inventive method, components (D) through (F) are uniformly mixed first to form a silicone compound. Components (A) through (C) are mixed with a silicone compound in step (I).

In one embodiment of the present inventive method, the mixing for step (I) is provided from a twin-screw extruder. In a more preferred embodiment, the time period for mixing in a twin screw extruder is less than 3 minutes, or alternatively less than 2 minutes.

The second step (II) of the method of the present invention is statically vulcanizing the organop lysiloxane. The static vulcanizing step cures the organopolysiloxane. Step (II) occurs following the mixing step (I). Static vulcanization refers to vulcanizing the organopolysiloxane without further mixing of the product of step (I). For example, the product of mixing from step (I) can be simply subjected to a process to cure the organopolysiloxane, such as heating the product of step (I). Typically, the product of step (I) is heated at a temperature sufficient to cure the organopolysiloxane. This temperature will depend on whether a cure agent is present and its chemical nature. In a preferred embodiment, the cure agent is present and is an organic peroxide, as discussed supra. In this embodiment, half life of the organic peroxide much be short enough for time and temperature constraints of step (II). Depending on the selection of the cure agent, vulcanization can occur at atmospheric conditions.

The present invention also relates to the elastomeric compositions prepared according to the methods taught herein, and further to the cured elastomeric compositions prepared therefrom. The inventors believe the techniques of the present invention provide unique and useful elastomeric compositions, as demonstrated by the inherent physical properties of the elastomeric compositions, vs compositions of similar combinations of elastomers and silicone bases prepared by other methods or techniques. Furthermore, the cured elastomer compositions, as described infra, prepared from the elastomeric compositions of the present invention also possess unique and useful properties. For example, cured elastomers prepared from the elastomeric compositions of the present invention have surprisingly good low and high temperature properties and improved processability.

The cured elastomeric compositions of the present invention can be prepared by curing the elastomer component (A) of the elastomeric composition of the present invention via known curing techniques. Curing of elastomers, and additional components added prior to curing, are well known in the art and will depend on the selection of elastomers (A). Any of these known techniques, and additives, can be used to cure the elastomeric compositions of the present invention and prepare cured elastomers therefrom.

Additional components can be added to the elastomeric compositions prior to curing the elastomer component. These include blending other elastomers or other elastomeric compositions into the elastomeric compositions of the present invention. These additional components can also be any component or ingredient typically added to an elastomer or elastomer gum for the purpose of preparing a cured elastomer composition. Typically, these components can be selected from, fillers, processing aids, and curatives. Many commercially available elastomers can already comprise these additional components. Elastomers having these additional components can be used as component (A), described supra, providing they do not prevent the static vulcanization of the silicone base in step (II) of the method of this invention. Alternatively, such additional components can be added to the elastomeric composition prior to the final curing of the elastomer component.

The cured elastomer composition may also comprise a filler. Examples of fillers include carbon black; coal dust fines; silica; metal oxides, e.g., iron oxide and zinc oxide; zinc sulfide; calcium carbonate; wollastonite, calcium silicate, barium sulfate, and others known in the art.

The cured elastomer compositions are useful in a variety of applications such as to construct various articles of manufacture illustrated by but not limited to O-rings, gaskets, seals, liners, hoses, tubing, diaphragms, boots, valves, belts, blankets, coatings, rollers, molded goods, extruded sheet, caulks, and extruded articles, for use in applications areas which include but not are limited to transportation including automotive, watercraft, and aircraft; chemical and petroleum plants; electrical: wire and cable: food processing equipment; nuclear power plants; aerospace; medical applications; and the oil and gas drilling industry and other applications which typically use high performance elastomers such as ECO, FKM, HNBR, acrylic rubbers and silicone elastomers.

### EXAMPLES

The following examples are presented to further illustrate the compositions and method of this invention, but are not construed as limiting the invention, which is delineated in the appended claims. All parts and percentages in the examples are on a weight basis and all measurements were obtained at approximately 23° C., unless otherwise indicated.

Materials

GP-50 is a silicone rubber base marketed by Dow Coming Corporation (Midland, Mich.) as Silastic ® GP-50.

LS-2840 is a silicone rubber base marketed by Dow Coming Corporation (Midland, Mich.) as Silastic® LS-2840 Fluorosilicone Rubber.

LS 5-2040 is a silicone rubber base marketed by Dow Corning Corporation (Midland, Mich.) as Silastic® LS 5-2040 Fluorosilicone Rubber.

LS 4-9040 is a silicone rubber base marketed by Dow Coming Corporation (Midland, Mich.) as Silastic® LS 4-9040 Fluorosilicone Rubber.

HT-1 is a masterbatch of ceric hydroxide in a dimethyl silicone rubber carrier and is marketed by Dow Coming Corporation (Midland, Mich.) as Silastic® HT-1 Modifier.

TAIC is Triallyl-1,3,5-triazine-2,4,6-(1H,3H,5H)-trione (CAS# 1025-15-6), also known as triallyl isocyanurate, marketed by Aldrich Chemical Company, Inc.

Luperox F is Di-(2-tert-butylperoxyisopropyl) benzene(s) and is marketed by Atofina Chemicals, Inc. as LUPEROX® F.

VAROX is 2,5-dimethyl-2,5-di(tert-butylperoxy)hexane on an inert filler marketed by R.T. Vanderbilt, Company, Inc. as VAROX® DBPH-50.

N990 is carbon black (CAS# 1333-86-4) marketed by Degussa Engineered Carbons as Thermal Black N 990.

Austin Black is a carbon black marketed by Coal Fillers Incorporated as Austin Black®.

ZnO is zinc oxide USP powder (CAS# 1314-13-2) C. P. Hall and the Zinc Corporation of America.

Silicone Compound A is a silicone compound based on Silastic® LCS-755 Silicone Rubber (100 parts) marketed by Dow Corning Corporation (Midland, Mich.), 9330 Zinc Oxide Transparent (5 parts) marketed by Akrochem Corporation and VAROX (0.4 parts).

EPDM is a low-diene containing ethylene-propylene terpolymer (EPDM) and marketed by Dupont Dow Elastomers, LLC as Nordel® NDR 3640.00.

G902 is 1-Propene, 1,1,2,3,3,3-hexafluoro-polymer with 1,1-difluoroethene and tetrafluoroethene Iodine modified fluoroelastomer (CAS# 25190-89-0) and is marketed by Daikin America, Inc. as DAI-EL™ Fluoroelastomer G-902.

Testing

The tensile, elongation, and 100% modulus properties of the cured elastomeric compositions were measured by a procedure is based on ASTM D 412. Shore A Durometer was measured by a procedure is based on ASTM D 2240. Permeation was evaluated using Payne cups by a modified ASTM E96 method. CE10 test fuel is 10 volume percent ethanol in Reference Fuel C. CE10 was placed in the permeation cup, a rubber diaphragm was the placed on top of the cup then secured with a sealing rig held down with setscrews. The cup was inverted for direct fuel contact on the diaphragm. Weight loss measurements were taken until the permeation rate was constant. Permeation rates were calculated per ASTM E96 using the surface area of the diaphragm and reported in mm·grams/m²·day units.

### Example 1

GP-50 (60 g) and Luperox F (0.2 g) were mixed on a 2-roll mill to form a silicone compound. This silicone compound (60.2 g) and EPDM (140 g) were added to a 379 ml Haake mixer equipped with Banbury rotors at 150° C. and 100 rpm (revolutions per minute). After about 2.5 minutes and before a torque increase, the material temperature was removed and placed in a press for 10 minutes at 177° C. The elastomeric composition was split into to portions. 1A was further compounded as is. 1B was heat aged for 16 hr/90° C., then compounded. The resulting EPDM elastomeric compositions (50 g) were compounded on a 2-roll mill with Varox (3 g) and N990 (8 g), Austin Black (4 g) and ZnO (2 g) and the components were mixed until homogenous.

### Example 2

Without compounding, GP-50 (60 g) and EPDM (140 g) were added to a 379 ml Haake mixer equipped with Banbury rotors at 150° C. and 100 rpm (revolutions per minute). After about 2.5 minutes the elastomeric blend was removed. The elastomeric blend was split into to portions. 2A was further compounded as is. 2B was heat aged for 16 hr/90° C., then compounded. The resulting elastomeric blends (50 g) were compounded on a 2-roll mill with Luperox F (0.05 g), Varox (3 g) and N990 (8 g), Austin Black (4 g) and ZnO (2 g) to give the same final ingredients as Example 1, and the components were mixed until homogenous.

Examples 1-2 were pressed cured at 177° C. for 20 minutes. The physical properties of the resulting cured elastomeric compositions and the blend are summarized in Table 1.

TABLE 1

| | Example # | | | |
|---|---|---|---|---|
| | 1A | 1B | 2A | 2B |
| Shore A Durometer | 57 | 58 | 55 | 56 |
| Tensile strength, MPa | 6.58 | 6.57 | 5.13 | 4.71 |
| Elongation, % | 191 | 192 | 218 | 209 |

### Example 3

For Sample 3A, Silicone Compound A (142 g) and G902 (344 g) were added to a 310 ml Haake mixer equipped with banbury rollers at 90° C. and 125 rpm (revolutions per minute). The blend was removed when it reached 130° C. and before a torque increase, then placed in a press for 10 minutes at 200° C. to form a FKM elastomeric composition with a ML (1+10) @ 121° C. of 43. Sample 3B is the same as Sample 3A except, for Sample 3B, the blend was allowed to reach 160° C., react and was then removed five minutes after a torque increase to give a FKM elastomeric composition with a ML (1+10) @ 121° C. of 67. The resulting FKM elastomeric compositions (100 parts) were compounded in the Haake then on a mill until uniform with ZnO (3.44 parts), Varox (2.06 parts), and TAIC (2.75 parts). The samples were press cured for 10 minutes at 160° C., and then post-cured for 4 hours at 200° C. Sample 3A had a Shore A Durometer of 60, a Tensile Strength of 7.39 Mpa, an Elongation of 320%, and a permeation of 708 mm·g/day·m². Sample 3B had a Shore A Durometer of 61, Tensile Strength of 9.45 MPa, an Elongation of 295%, and a permeation of 2508 mm·gm/m²·day.

### Example 4

LS-2840 (100 parts), ZnO (5 parts), HT-1 (1 part), and Varox (0.8 parts) were mixed on a 2-roll mill to form a silicone compound. This silicone compound (257 g) and G902 (229 g) were added to a 310 ml Haake mixer equipped with banbury rollers at 150° C. and 125 rpm (revolutions per minute). For Sample 4A, the blend was removed when it reached 150° C. and before a torque increase, then placed in a press for 10 minutes at 177° C. to form a FKM elastomeric composition. For Sample 4B, the blend was allowed to react in the Haake and removed five minutes after a torque increase.

The resulting FKM elastomeric compositions (100 parts) were compounded in the Haake then on a mill until uniform with ZnO (2.35 parts), Varox (1.41 parts), and TAIC (1.88 parts). The samples were press cured for 10 minutes at 160° C., and then post-cured for 4 hours at 200° C. The physical properties are listed in Table 2.

### Example 5

Sample 5A and 5B were prepared the same as Sample 4A and 4B except LS-2840 was replaced with LS 5-2040. The physical properties are listed in Table 2.

### Example 6

Sample 6A and 6B were prepared the same as Sample 4A and 4B except LS-2840 was replaced with LS 4-9040 and 252 g of the silicone compound was used. The physical properties are listed in Table 2.

TABLE 2

| | 2A | 2B | 3A | 3B | 4A | 4B |
|---|---|---|---|---|---|---|
| Permeation | 850 | 1129 | 902 | 1143 | 1064 | 1244 |
| mm · gm/day · m² | | | | | | |
| Tensile strength, MPa | 6.90 | 6.93 | 6.42 | 6.64 | 5.04 | 6.27 |
| Elongation, % | 341 | 335 | 423 | 339 | 284 | 303 |
| Shore A Durometer | 55 | 59 | 53 | 56 | 50 | 51 |

### Example 7

A FKM elastomeric composition was prepared using a 25 mm Werner and Pfleiderer twin-screw extruder with the processing section heated to 50° C. and a screw speed of 300 rpm at an output rate of 20 kg/hr. The process began with the addition of Silicone Compound A at a feed rate of 70 grams/minute, followed by fluorocarbon elastomer (G902) to the extruder at a feed rate of 264 grams/minute. The blend was extruded in strips into a 12-foot horizontal oven set at 350° C. The resulting FKM elastomeric composition (100 parts) was compounded in a Haake then on a mill until uniform with ZnO (3.69 parts), Varox (2.21 parts), and TAIC (2.95 parts). The sample was press cured for 10 minutes at 160° C., and then post-cured for 4 hours at 200° C. to give a Shore A Durometer of 63, a Tensile Strength of 9.3 MPa, an Elongation of 395% and a permeation of 634 mm·gm/m²·day.

1. A method for preparing an elastomeric composition comprising:
(I) mixing;
(A) an elastomer,
(B) an optional compatibilizer,
(C) an optional catalyst,
(D) a silicone base comprising a curable organopolysiloxane,
(E) an optional crosslinking agent,
(F) a cure agent in an amount sufficient to cure said organopolysiloxane; and then,
(II) statically vulcanizing the organopolysiloxane,
wherein the weight ratio of elastomer (A) to silicone base (D) in the elastomeric base composition ranges from 95:5 to 30:70.

2. The method of claim 1 wherein the silicone base comprises;
(D′) a diorganopolysiloxane containing at least 2 alkenyl groups having 2 to 20 carbon atoms, and
(D″) an optional reinforcing filler.

3. The method of claim 2 wherein the crosslinking agent is present and is an organohydrido silicon compound.

4. The method of claim 3 wherein the cure agent is a platinum catalyst.

5. The method of claim 1 wherein the cure agent is a free radical initiator.

6. The method of claim 1 wherein the elastomer comprises a hydrogenated copolymer of butadiene and acrylonitrile, a terpolymer of ethylene, propylene, and diene, copolymer of vinylidene fluoride and hexafluoropropene , a terpolymer of vinylidene fluoride, hexafluoropropene, and tetrafluoroethene, or a terpolymer of vinylidene fluoride, tetrafluoroethene, and perfluoromethylvinyl ether.

7. The method of claim I wherein the compatibilizer (B) is present and is selected from;
(B¹) an organic compounds which contain 2 or more olefin groups,
(B²) organopolysiloxanes containing at least 2 alkenyl groups,
(B³) olefin-functional silanes which also contain at least one hydrolyzable group or at least one hydroxyl group attached to a silicon atom thereof,
(B⁴) an organopolysiloxane having at least one organofunctional groups selected from amine, amide, isocyanurate, phenol, acrylate, epoxy, and thiol groups,
(B⁵), a dehydrofluorination agent,
and any combinations of (B¹), (B²), (B³), (B⁴) and (B⁵).

8. The method of claim 1 wherein the catalyst (C) is present and is selected from an organic peroxide.

9. The method of claim 1 wherein components (D) through (F) are mixed first to form a silicone compound.

10. The method according to claim 1 wherein step I is performed in an extruder.

11. The method of claim 1 wherein the static vulcanization occurs by heating the mixture resulting from step I.

12. The product produced by the method of claim 1.

13. A cured elastomeric composition prepared from the product of claim 12.

14. An article of manufacture comprising the cured elastomeric composition of claim 13.
